(19) United States
(12) Patent Application Publication
(10) Pub. No.: US 2025/0108489 A1
(43) Pub. Date: Apr. 3, 2025

(54) WRENCH

(71) Applicant: Kenneth Dolph, West Seneca, NY (US)

(72) Inventor: Kenneth Dolph, West Seneca, NY (US)

(21) Appl. No.: 18/479,459

(22) Filed: Oct. 2, 2023

(51) Int. Cl. B25B 13/14

(52) U.S. Cl. CPC B25B 13/14

(57) ABSTRACT

A wrench, comprising a handle having a first end and a second end, a pair of jaws located at the second end of the handle and integral thereto, the first jaw comprising a raker and the second jaw comprising a pawl, the raker and the pawl spaced apart from one another in a divergent direction away from the handle to form a throat, the throat bounded by a first inwardly facing smooth surface of the raker and a second inwardly facing smooth surface of the pawl, wherein both the raker and the pawl extend in the form of a curve in a common direction, and wherein the first and second inwardly facing surfaces intersect to form a line at a deepest part of the throat. An adjustable version of the aforementioned wrench is also disclosed.

### FIELD

The present invention relates to hand tools, specifically, to a wrench having a toothless embodiment and a toothed embodiment.

### BACKGROUND

A wrench (American) or spanner (European) is a tool used to provide grip and mechanical advantage in applying torque to turn objects—usually rotary fasteners, such as nuts and bolts. The first patented wrench was invented by Solymon Merrick of Springfield, Massachusetts, in August of 1835. It is known that this was not the first wrench introduced to society. In the fifteenth century, wrenches were used to construct suits of armor and for securing pipe clamps for early plumping systems. Wrenches were commonly used in the early days of the thirteen colonies for adjusting, repairing, and maintaining wagon wheels, and were exported from England to the Americans during the late eighteenth and early nineteenth century.

Today, there are various types of wrenches having specific uses.

An open-end wrench is a one-piece wrench with a U-shaped opening that grips two opposite faces of a bolt or nut. This wrench is often double-ended, with a different-sized opening at each end. The ends are generally oriented at an angle of around 15 degrees relative to the longitudinal axis of the handle. This allows a greater range of movement in enclosed spaces by flipping the wrench over.

A box-end wrench is a one-piece wrench with an enclosed opening that grips the face of the bolt or nut. The recess is generally a six-point or twelve-point opening for use with nut or bolt heads with a hexagonal shape. The twelve-point opening fits onto the fastening (nut or bolt) at twice as many angles, an advantage where swing is limited. This also increases the transmitted torque. Eight-point wrenches are also made for square-shaped nuts and bolt heads. Ring spanners are often double-ended and usually with offset handles to improve access to the nut or bolt.

A combination wrench is a double-ended tool with one end forming an open-end wrench or open-ended spanner, and the other end forming a box-end wrench or ring spanner. Both ends generally fit the same size of nut, bolt or fastener.

A flare-nut wrench (also known as a tube wrench or line wrench) is a wrench that is used for gripping the nuts on the ends of tubes. It is similar to a box-end wrench but, instead of encircling the nut completely, it has a narrow opening just wide enough to allow the wrench to fit over the tube, and thick jaws to increase the contact area with the nut. This allows for maximum contact on plumbing nuts, which are typically softer metals and therefore more prone to damage from open-ended wrenches.

A ratcheting box wrench is a type of ring spanner, or box wrench, whose end section ratchets. Ratcheting can be reversed by flipping over the wrench, or by activating a reversing lever on the wrench. This type of wrench combines the compact design of a box wrench, with the utility and quickness of use of a ratchet wrench. A variety of ratcheting mechanisms are used, from simple pawls to more complex captured rollers, with the latter being more compact, smoother, but also more expensive to manufacture.

A flex-head socket wrench (or a “Saltus” wrench) is similar in concept to a socket wrench. A Saltus wrench features a socket permanently affixed to a handle. Sockets are not interchangeable as with a socket wrench. The socket often rotates around the handle to allow the user to access a fastener from a variety of angles. Commonly a Saltus wrench is part of a double-ended wrench, with an open-end type head on the opposite side from the socket head.

A spanner wrench (or simply “spanner”, pin spanner, hook spanner, C spanner, or pin face spanner) is a wrench with one or several pins or hooks, designed to drive spanner head screws, threaded collars and retainer rings, shafts, and so on.

An adjustable wrench or Crescent wrench is one of the most popular adjustable wrenches in use today. The adjustable end wrench differs from the monkey wrench in that the gripping faces of the jaws are displaced to a (typically) 15° angle relative to the tool's handle, a design feature that facilitates the wrench's use in close quarters.

In one prior example, Published International Application No. WO19904935 (hereinafter “Hedin”) teaches an arrangement for a pipe wrench having a pair of fixed jaws extending from a handle, where the opening or “mouth” of the jaws diverges in a direction away from an inner section of the wrench. One of the jaws includes teeth extending therefrom, or other like means to provide an improved grip on an object to be tightened or loosened. Hedin does not teach both inner surfaces of the jaws having a substantially smooth surface.

As evidenced by the plurality of available types of wrenches, having a single wrench for a plurality of applications is desirable. Not only does this eliminate the need for a variety of different sizes and types of wrenches, it reduces costs to the users, while also reducing the need for transporting multiple sizes of a particular wrench and different wrench types altogether.

Thus, there is a long-felt need for a wrench that can fit a plurality of different sized fasteners and has a structure allowing for a rachet-like wrenching application without the need for ratcheting mechanisms.

### SUMMARY

Generally, the present invention comprises a wrench, comprising a handle having a first end and a second end, a pair of jaws located at the second end of the handle and integral thereto, the first jaw comprising a raker and the second jaw comprising a pawl, the raker and the pawl spaced apart from one another in a divergent direction away from the handle to form a throat, the throat bounded by a first inwardly facing smooth surface of the raker and a second inwardly facing smooth surface of the pawl, wherein both the raker and the pawl extend in the form of a curve in a common direction, and wherein the first and second inwardly facing surfaces intersect to form a line at a deepest part of the throat.

In some embodiments, the pawl of the aforementioned wrench may have a plurality of teeth extending from the second inwardly facing smooth surface.

In other arrangements, the aforementioned first inwardly facing smooth surface of the raker may have a first arch angle and the aforementioned second inwardly facing smooth surface of the pawl may have a second arch angle, where the first arch angle is greater than the second arch angle.

The present invention could also comprise an adjustable wrench, the adjustable wrench including a handle having a first end and a second end, and a pair of jaws located at the second end of the handle, a first jaw of the pair of jaws including a raker extending from and integral to the handle, a second jaw of the pair of jaws including a pawl slidably attached to the handle proximate the second end thereof, the raker and the pawl spaced apart from one another in a divergent direction away from the handle to form a throat, the throat bounded by a first inwardly facing smooth surface of the raker and a second inwardly facing smooth surface of the pawl, wherein both the raker and the pawl extend in the form of a curve in a common direction, and wherein the first and second inwardly facing surfaces intersect to form a line at a deepest part of the throat.

In other embodiments, the aforementioned adjustable wrench may further comprise a channel disposed within the handle proximate the second end, wherein the pawl has a serrated edge extending therefrom and slidably arranged within the channel, and a screw disposed within the handle and adjacent the channel, the screw having a plurality of threads at least partially disposed within the channel and arranged to engage the serrated edge of the pawl, where rotation of the screw slidably moves the pawl within the channel, thereby increasing or decreasing a width of an opening of the throat.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of a first embodiment of the present invention;

FIG. 2 is a rear perspective view of the invention shown in FIG. 1;

FIG. 3 is a top view of the invention shown in FIG. 1;

FIG. 4A is a perspective view of a second embodiment of the present invention;

FIG. 4B is an enlarged view taken generally from DETAIL 4B in FIG. 4A;

FIG. 4C is the view from FIG. 4B showing an alternative configuration thereof;

FIG. 5 is a top view of the invention shown in FIG. 4A;

FIG. 6 illustrates the invention shown in FIG. 1 in use;

FIG. 7A illustrates a perspective view of an adjustable embodiment of the present invention;

FIG. 7B is a cross-sectional view taken generally along line 7B-7B in FIG. 7A; and,

FIG. 7C is a cross-sectional view taken generally along line 7C-7C in FIG. 7A.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims. Those in the art will understand that any suitable material, now known, or hereafter developed, may be used in forming the present invention described herein.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be noted that the terms “including”, “includes”, “having”, “has”, “contains”, and/or “containing”, should be interpreted as being substantially synonymous with the terms “comprising” and/or “comprises”.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

The terms “distal” or “distally” are intended to be exemplary directional terms and should be interpreted to mean that a first component is arranged away from a second component. Likewise, the terms “proximal” or “proximally” are intended to be exemplary directional terms and should be interpreted to mean that a first component is arranged close to a second component.

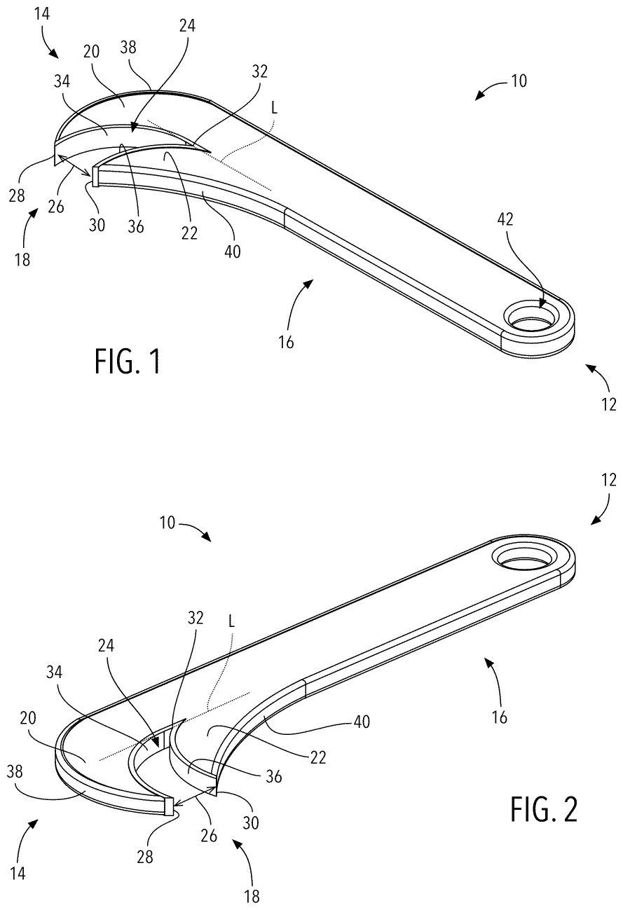

Adverting now to the figures, FIGS. 1 and 2 illustrate perspective views of a first embodiment of the present invention, wrench 10. Generally, wrench 10 comprises handle 16 disposed proximate first end 12 and jaws 18 disposed proximate second end 14. Jaws 18 extend from and are integral to handle 16. Jaws 18 are defined by raker 20, pawl 22, and throat 24 disposed therebetween. Raker 20 is bounded by first inner curved surface 34 and first outer curved surface 38. First inner curved surface 34 and first outer curved surface 38 intersect and terminate at first tip 28. Pawl 22 is bounded by second inner curved surface 36 and second outer curved surface 40. Second inner curved surface 36 and second outer curved surface 40 intersect and terminate at second tip 30. Mouth 26 of throat 24 is defined by first tip 28 and second tip 30. Throat 24 is formed by first inner curved surface 34 and second inner curved 36, which intersect and terminate at intersection 32. Thus, first inner curved surface 34 is defined by tip 28 and intersection 32 and second inner curved surface 36 is defined by tip 30 and intersection 32. In a preferred embodiment, both first inner curved surface 34 and second inner curved surface 36 of wrench 10 are smooth.

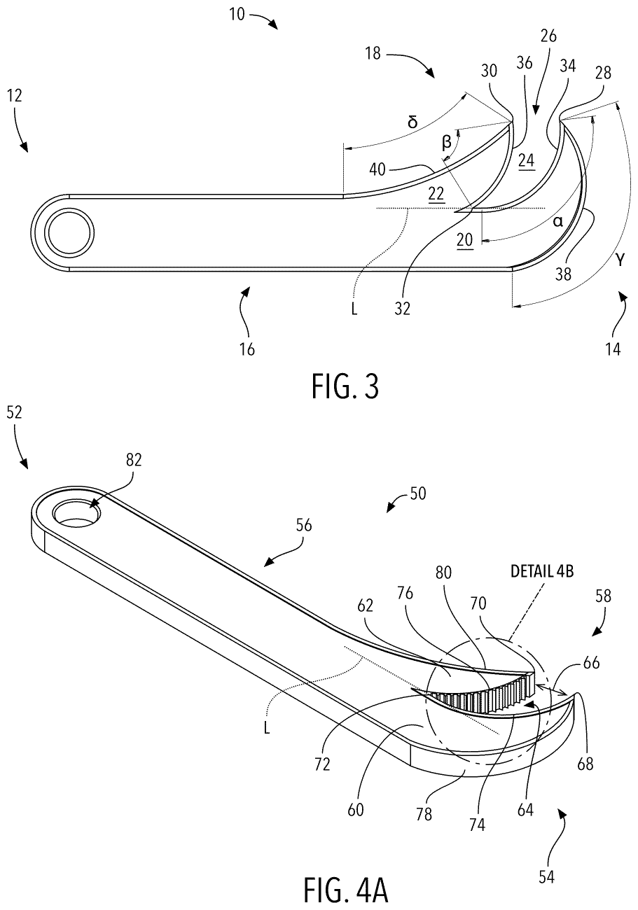

FIG. 3 illustrations a top view of wrench 10. First inner curved surface 34 of raker 20 has first arch angle α. Second inner curved surface 36 of pawl 22 has arc angle β. First outer curved surface 38 of raker 20 has third arc angle γ. Second outer curve surface 40 of pawl 22 has fourth arc angle δ. In a preferred embodiment, the relationships of arc angles α, β, γ, and δ, are as follows:
α>β
γ>α
β>δ
γ>δ

In a preferred embodiment, raker 20 and pawl 22 spaced apart from one another in a divergent direction away from handle 16 to form throat 24, where both raker 20 and pawl 22 extend in the form of a curve in a direction towards first end 12, and where first inner curved surface 34 and second inner curved surface 36 intersect at intersection 32, forming line L at a deepest part of throat 24.

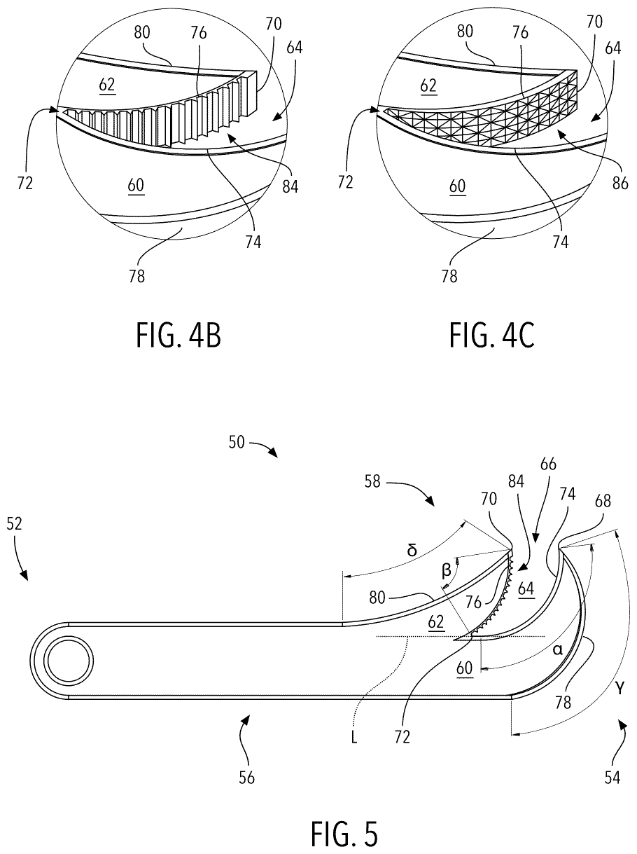

Adverting now to FIGS. 4A through 5, which generally illustrates a second embodiment of the present invention. Specifically, FIG. 4A shows a perspective view of wrench 50, FIG. 4B illustrates an enlarged view taken from FIG. 4A, FIG. 4C shows the same enlarged view of FIG. 4B having an alternative configuration, and FIG. 5 illustrates a top view thereof.

Generally, wrench 50 comprises handle 56 disposed proximate first end 52 and jaws 58 disposed proximate second end 54. Jaws 58 extend from and are integral to handle 56. Jaws 58 are defined by raker 60, pawl 62, and throat 64 disposed therebetween. Raker 60 is bounded by first inner curved surface 74 and first outer curved surface 78. First inner curved surface 74 and first outer curved surface 78 intersect and terminate at first tip 68. Pawl 62 is bounded by second inner curved surface 76 and second outer curved surface 80. Second inner curved surface 76 and second outer curved surface 80 intersect and terminate at second tip 70. Mouth 66 of throat 64 is defined by first tip 68 and second tip 70. Throat 64 is formed by first inner curved surface 74 and second inner curved surface 76, which intersect and terminate at intersection 72. Thus, first inner curved surface 74 is defined by tip 68 and intersection 72 and second inner curved surface 76 is defined by tip 70 and intersection 72. In a preferred embodiment, only first inner curved surface 74 is smooth, whereas second inner curved surface 76 includes plurality of teeth 84 extending therefrom. Each of plurality of teeth 84 may take a pointed protrusion-like form (as generally illustrated), however it should be noted that a variety of configuration are contemplated within the scope of the appending claims. For example, plurality of teeth 84 could be configured as a knurled texturing (generally shown in FIG. 4C), knurling 86, on second inner curved surface 76, a plurality of trapezoidal-like protrusions, domed-protrusions and/or indentations, etc. As such, it should be understood that plurality of teeth 84 may be the form of any known grip-enhancing configurations that assists a user of wrench 50 in tightening or loosening a particular member (e.g., nuts, bolts, etc.).

FIG. 5 illustrations a top view of wrench 50. First inner curved surface 74 of raker 60 has first arch angle α. Second inner curved surface 76 of pawl 62 has arc angle β. First outer curved surface 78 of raker 60 has third arc angle γ. Second outer curve surface 80 of pawl 62 has fourth arc angle δ. In a preferred embodiment, the relationships of arc angles α, β, γ, and δ, are as follows:

α>β

γ>α

β>δ

γ>δ

In a preferred embodiment, raker 60 and pawl 62 spaced apart from one another in a divergent direction away from handle 56 to form throat 64, where both raker 60 and pawl 62 extend in the form of a curve in a direction towards first end 52, and where first inner curved surface 74 and second inner curved surface 76 intersect at intersection 72, forming line L at a deepest part of throat 64.

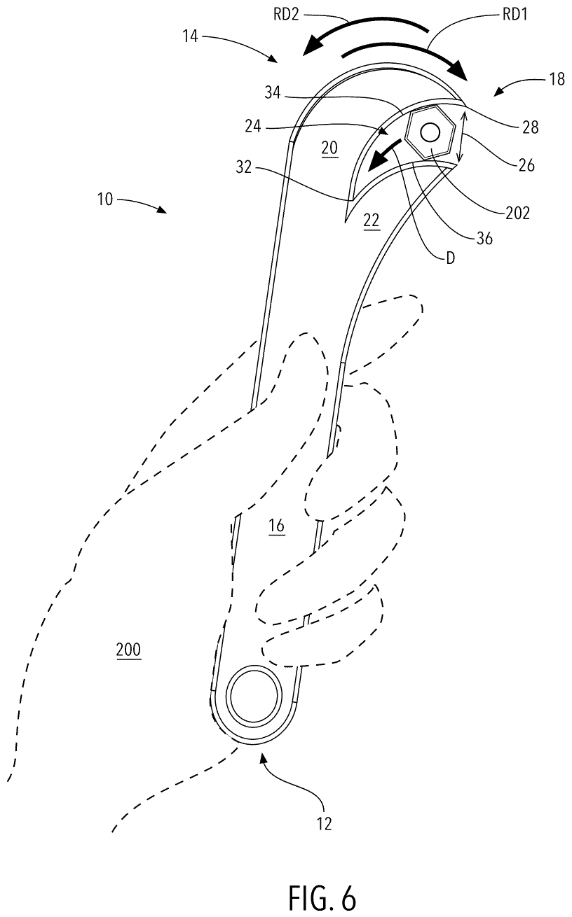

Adverting now to FIG. 6, which generally shows a perspective view of wrench 10 in use. It should be noted that the description of FIG. 6 applies to all of the disclosed embodiments of the present invention and is an exemplary illustration. In use, handle 16 of wrench 10 is held by hand 200. Within throat 24 is bolt 202, abutting both first inner curved surface 34 of raker 20 and second inner curved surface 36 of pawl 22. When wrench 10 rotates in rotational direction RD1 (to turn bolt 202 in a clockwise direction), bolt 202 moves in direction D (towards intersection 32 of first inner curved surface 34 and second inner curved surface 36), thereby increasing the force both first inner curved surface 34 and second inner curved surface 36 apply on an outer surface of bolt 202 (due to the decreasing width of throat 24 towards intersection 32). In other words, once bolt 202 is within mouth 26 of jaws 18, bolt 202 will move in direction D down throat 24 towards intersection 32 and once bolt 202 contacts first inner curved surface 34 of raker 20 and second inner curved surface 36 of pawl 22, wrench 10 may be turned in rotational direction RD1 because first inner curved surface 34 of raker 20 draws bolt 202 into and forcibly into second inner curved surface 36 of pawl 22—thus assuring jaws 18 do not lose grip on bolt 202 (or any other object to be turned). The aforementioned action of wrench 10 is released on bolt 202 when wrench 10 is turned in rotational direction RD2, substantially allowing for wrench 10 to perform a ratchet-like on any object to be turned. As such, to turn bolt 202 in a counter-clockwise direction, wrench 10 must be flipped, as wrench 10 always rotates objects in relation to rotational direction RD1 and tip 28 and releases objects from throat 24 when rotated in rotational direction RD2.

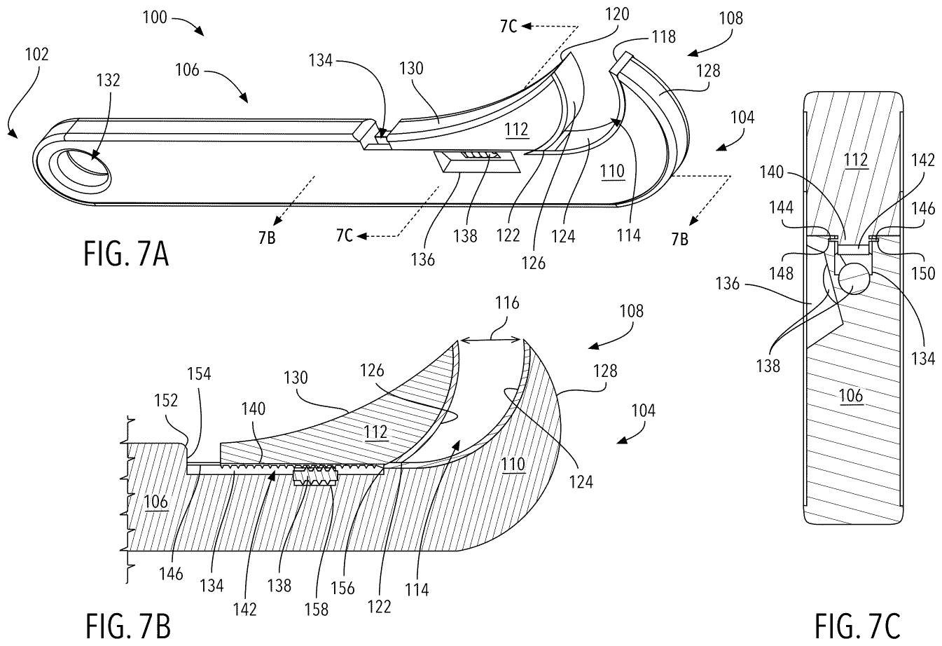

Lastly, FIGS. 7A through 7C illustrate an adjustable version of the present invention, wrench 100, specifically, a perspective view thereof and cross-sectional views taken generally along lines 7B-7B and 7C-7C in FIG. 7A.

Generally, wrench 100 comprises handle 106 disposed proximate first end 102 and adjustable jaws 108 disposed proximate second end 104. Adjustable jaws 108 extend from and handle 106, whereas raker 110 is integral to handle 106 (like in wrenches 10 and 50, described supra) and adjustable pawl 112 is slidably connected to handle 106. Raker 110 is generally defined by first inner curved surface 124 and first outer curved surface 128. First inner curved surface 124 and first outer curved surface 128 intersect and terminate at first tip 118. Adjustable pawl 112 is generally defined by second inner curved surface 126, second outer curved surface 130, and attachment protrusion 140. Second inner curved surface 126 and second outer curved surface 130 intersect and terminate at second tip 120. Adjustable mouth 116 of adjustable throat 114 is defined by first tip 118 and second tip 120. Adjustable throat 114 is formed by first inner curved surface 124 and second inner curved surface 126, which intersect and terminate at adjustable intersection 122. Adjustable intersection 122 is an end point on second inner curved surface 126 that is generally positioned on line L. e.g., adjustable intersection 122 moves with adjustable pawl 112. Thus, first inner curved surface 124 and second inner curved surface 126 intersect (at adjustable intersection 122) on line L.

In a preferred embodiment of wrench 100, similar to wrenches 10 and 50, first inner curved surface 124 of raker 110 is a smooth surface. Second inner curved surface 126 of adjustable pawl 112 may have teeth, knurling, or the like, thereon (similar to FIGS. 4B and/or 4C).

In some embodiments, handle 106 includes channel 134 arranged therein and proximate second end 104. Adjustable pawl 112 is slidably connected within channel 134 and is arranged to move therein (i.e., substantially between rear edge 152 and forward edge 154 as shown in FIG. 7B). Attachment protrusion 140 (shown in FIGS. 7B and 7C) extends from adjustable pawl 112, opposite of second outer curved surface 130. Serrated edge 142 extends distally from attachment protrusion 140. Tongues 144 and 146 extend from respective sides of attachment protrusion 140. Tongues 144 and 146 are arranged to be seated within grooves 148 and 150 of channel 134, such that they may slide therein (substantially between rear edge 152 and forward edge 154). Cutout 158 is positioned distally within channel 134 and rotatably hold screw 138 therein. Screw 138 is preferably a worm screw which engages protrusions or teeth of serrated edge 142, such that rotating screw 138 moves serrated edge 142 between rear edge 152 and forward edge 154 (i.e., moves adjustable pawl 112 closer or farther away from first inner curved surface 124 of raker 110. In some embodiments, window 136 is arranged within handle 106 which is open to cutout 158—allowing access to screw 138 and affording a variable width of adjustable throat 114 of adjustable jaws 108 via rotation of screw 138.

It should be noted that inner curved surfaces 124 and 126 of wrench 100 have substantially identical arc angles of inner curved surfaces 34 and 36 of wrench 10 (shown in FIG. 3) and that outer curved surfaces 128 and 130 of wrench 100 have substantially identical arc angles of outer curved surfaces 38 and 40 of wrench 10 (shown in FIG. 3).

As such, the shown and described embodiments are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMBERS

10 Wrench
12 First end
14 Second end
16 Handle
18 Jaws
20 Raker
22 Pawl
24 Throat
26 Mouth
28 First tip
30 Second tip
32 Intersection
34 First inner curved surface
36 Second inner curved surface
38 First outer curved surface
40 Second outer curved surface
42 Aperture
50 Wrench
52 First end
54 Second end
56 Handle
58 Jaws
60 Raker
62 Pawl
64 Throat
66 Mouth
68 First tip
70 Second tip
72 Intersection
74 First inner curved surface
76 Second inner curved surface
78 First outer curved surface
80 Second outer curved surface
82 Aperture
84 Plurality of teeth
86 Knurling
100 Wrench
102 First end
104 Second end
106 Handle
108 Adjustable jaws
110 Raker
112 Adjustable pawl
114 Adjustable throat
116 Adjustable mouth
118 First tip
120 Second tip
122 Adjustable intersection
124 First inner curved surface
126 Second inner curved surface
128 First outer curved surface
130 Second outer curved surface
132 Aperture
134 Channel
136 Window
138 Screw
140 Attachment protrusion
142 Serrated edge
144 Tongue
146 Tongue
148 Groove
150 Groove
152 Notch
154 Rear edge
156 Forward edge
158 Cutout
200 Hand
202 Bolt
L Line
D Direction
RD1 Rotational direction
RD2 Rotational direction
α Arc angle
β Arc angle
γ Arc angle
δ Arc angle

What is claimed is:

1. A wrench, comprising:
a handle having a first end and a second end;
a pair of jaws located at said second end of said handle and integral thereto, said first jaw comprising a raker and said second jaw comprising a pawl, said raker and said pawl spaced apart from one another in a divergent direction away from said handle to form a throat, said throat bounded by a first inwardly facing smooth surface of said raker and a second inwardly facing smooth surface of said pawl, wherein both the raker and the pawl extend in the form of a curve in a common direction, and wherein said first and second inwardly facing surfaces intersect to form a line at a deepest part of said throat.

2. The wrench recited in claim 1 further comprising a plurality of gripping teeth extending from said second inwardly facing smooth surface.

3. The wrench recited in claim 1, wherein said first inwardly facing smooth surface has a first arch angle and said second inwardly facing smooth surface has a second arch angle, said first arch angle is greater than said second arch angle.

4. The wrench recited in claim 3, wherein said raker has a first outwardly facing curved smooth surface and said pawl has a second outwardly facing curved smooth surface.

5. The wrench recited in claim 1, wherein said raker has a first tip and said pawl has a second tip, wherein said throat decreases in width distally from said first tip and said second tip.

6. The wrench recited in claim 4, wherein said first outwardly facing smooth surface has a third arc angle and said second outwardly facing smooth surface has a fourth arc angle, said third arc angle greater than said fourth arc angle.

7. The wrench recited in claim 6, wherein said third arc angle is greater than said first arc angle and said second arc angle is greater than said fourth arc angle.

8. The wrench recited in claim 1 further comprising knurling on said second inwardly facing smooth surface.

9. A wrench, comprising:
a handle having a first end and a second end; and,
pair of jaws located at said second end of said handle, a first jaw of said pair of jaws including a raker extending from and integral to said handle, a second jaw of said pair of jaws including a pawl slidably attached to said second end of said handle, said raker and said pawl spaced apart from one another in a divergent direction away from said handle to form a throat, said throat bounded by a first inwardly facing smooth surface of said raker and a second inwardly facing smooth surface of said pawl, wherein both the raker and the pawl extend in the form of a curve in a common direction, and wherein said first and second inwardly facing surfaces intersect to form a line at a deepest part of said throat.

10. The wrench recited in claim 9 further comprising a plurality of gripping teeth extending from said second inwardly facing smooth surface.

11. The wrench recited in claim 9 further comprising knurling on said second inwardly facing smooth surface.

12. The wrench recited in claim 9, wherein said first inwardly facing smooth surface has a first arch angle and said second inwardly facing smooth surface has a second arch angle, said first arch angle greater than said second arch angle.

13. The wrench recited in claim 12, wherein said raker has a first outwardly facing curved smooth surface and said pawl has a second outwardly facing curved smooth surface.

14. The wrench recited in claim 9, wherein said raker has a first tip and said pawl has a second tip, wherein said throat decreases in width distally from said first tip and said second tip.

15. The wrench recited in claim 13, wherein said first outwardly facing smooth surface has a third arc angle and said second outwardly facing smooth surface has a fourth arc angle, said third arc angle greater than said fourth arc angle.

16. The wrench recited in claim 15, wherein said third arc angle is greater than said first arc angle and said second arc angle is greater than said fourth arc angle.

17. The wrench recited in claim 9 further comprising:
a channel disposed within said handle proximate said second end, wherein said pawl has a serrated edge extending therefrom and slidably arranged within said channel; and,
a screw disposed within said handle and adjacent said channel, said screw having a plurality of threads at least partially disposed within said channel and arranged to engage said serrated edge of said pawl.

18. The wrench recited in claim 17, wherein rotation of said screw slidably moves said pawl within said channel, thereby increasing or decreasing a width of an opening of said throat.
